(19) United States
(12) Patent Application Publication
(10) Pub. No.: US 2007/0080929 A1
(43) Pub. Date: Apr. 12, 2007

(54) Haptics transmission systems

(76) Inventor: Andrew J. Hardwick, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/572,967

(22) PCT Filed: Sep. 22, 2004
(86) PCT No.: PCT/GB04/04025

§ 371 Date: Mar. 21, 2006

(30) Foreign Application Priority Data
Sep. 30, 2003 (GB) 0322875.6

(51) Int. Cl. G09G 5/00

(52) U.S. Cl. 345/156

(57) ABSTRACT

In order to overcome the problems arising from network latency in haptic transmission systems a local PC (23, 24) attempts to build a force/position model of a remote haptic device (22, 21) so that when packetised position data is received through the network 5 signals controlling the motors of the local haptic device (21, 22) may be adjusted to reflect a predicted position still to be received. By using a local data model of the remote environment, the prediction may take account of reaction forces from objects/textures being simulated locally.

The present invention relates to haptics transmission systems and more particularly to a system incorporating improved latency correction and a method of improving latency correction.

The present invention relates to haptic communications and more particularly to improving the response of haptic devices coupled by way of a telecommunications network.

Tactile output from computers has been used to enhance game playing to provide a “feel”, for example vibration, thus adding an additional sensory perception to the games. Such outputs have also been used to enable visually impaired people to read documents and to feel drawings and the like. The basic operation of haptics output devices has been described in our published co-pending PCT Patent Application published as WO03/007136 which disclosed a method for adapting haptic interface output characteristics to correct for per-person differences in the sense of touch. In a further PCT patent application, publication no WO03/02885 there is disclosed a method of enabling reading of the Moon alphabet by use of a haptics output device. In the transmission of character sets from computers or data stores to haptics output devices there is unlikely to be any time critical activity dependent upon the output signals. However, where game play is involved, particularly if players are competing against each other or against the machine in a competitive manner, transmission delays of forward or reverse force parameters may have a significant impact on the sensed experience.

As game play is more likely to be carried out over a connectionless network, for example the internet or world wide web, rather than by a point to point communications link, signal latency may be introduced which can result in an inconsistency in the sensed movement of the output compared with the input.

Furthermore, sensory devices require frequent updates in both signal directions if the feel of the sensed movement and reaction to users response is to be realistic. The number of updates required to maintain realism, while not a problem where the haptic output device is in close proximity and direct connection to the generating processor, may result in the communications network overloading in a very short time and/or may require extreme allocations of bandwidth.

According to one aspect of the present invention there is provided a method of activating a haptic output device of the kind responsive to signals defining directional force comprising receiving a series of signals defining a multiplicity of data packets, each packet defining a position measured at one location for transmission to the current location, determining from packet data the information defining a position to which a haptic output device is expected to move, storing historic positional data defining each of a multiplicity of positions to which the haptic output device has moved, deriving a data model of the space in which directional forces are being applied at said one location and storing data defining said model, deriving from the historic positional data and the data defining the model an anticipated position and generating output signals defining force and direction to move the haptic output device towards said anticipated position and correcting for differences between the anticipated position and the transmitted position on receipt of subsequent positional data.

Preferably the method includes signalling in each direction whereby haptic forces applied at one device in reaction to an applied force towards the current defined position are reflected to a corresponding device in the form of current positional signals in a series of return data packets.

The method may include determining from the data model of the space the present of an impeding object whereby modification of the anticipated position and/or force may occur.

A feature of the present invention provides an interactive haptic output terminal in combination with a bi-directional transmission arrangement, the terminal comprising at least a haptic output device and control means, said control means receiving signals from said haptic output device to determine a current position for said device, and to determine from signals received from said transmission arrangement a preferred current position for said haptic output device, said control mean determining an output force and direction required to move said haptic output device from the current position to the preferred position, storing historic positional data defining each of a multiplicity of positions to which the haptic output device has moved, deriving a model of the space in which directional forces are being applied and storing data defining said model, deriving from the historic positional data and the data defining the model an anticipated position and generating output signals defining force and direction to move the haptic output device towards said anticipated position and correcting for differences between the anticipated position and the transmitted position on receipt of subsequent positional data.

The control means will receive signals from the haptic output device containing data defining the position of said device at any particular time and will convert said data to signals for transmission to said bi-directional transmission arrangement at predetermined intervals.

The signals defining a preferred current position may be generated by an environment simulator, for example a programmed computer, or may be generated by a corresponding interactive output terminal at the opposed end of the transmission arrangement.

Where a series of packets defining preferred position are received, each packet defining a directional force applied at one location for transmission to the current location, the control means may include means to determine from packet data the sequence of transmission and re-ordering the data into a numerically correct series, extrapolating from previously received packets an anticipated linear movement to be defined by subsequently received packets and applying output directional force signals corresponding to said anticipated linear movement in respect of any missing data packet.

A haptics transmission system in accordance with the invention will now be described by way of example only with reference to the accompanying drawings of which:

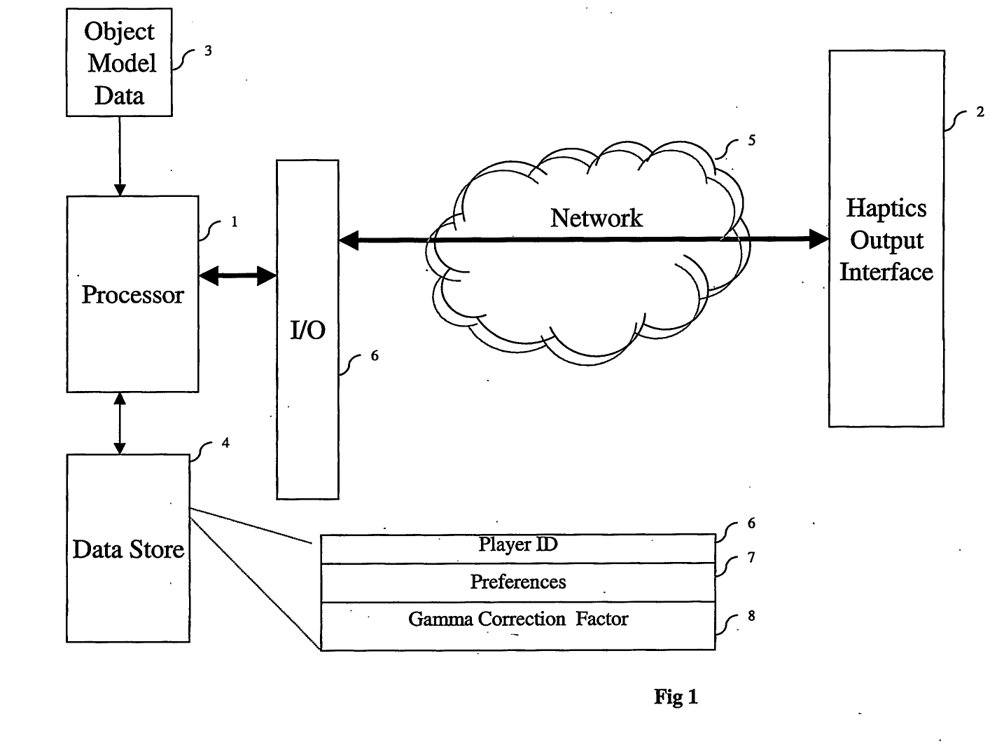

FIG. 1 is a block schematic diagram of a first haptics communications system in which a network interconnects an environmental simulation to a haptics input/output device;

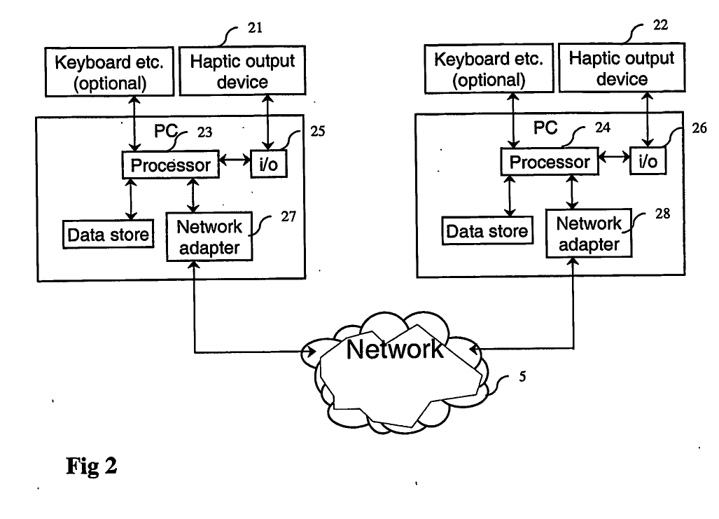

FIG. 2 is a block schematic diagram of a haptics communications system having a plurality of interconnected haptics input/output devices;

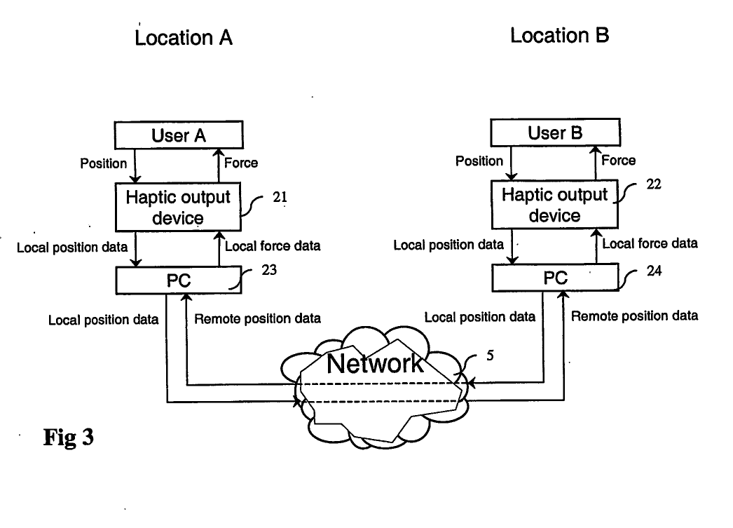

FIG. 3 is a schematic diagram of data interchange within the system of FIG. 2;

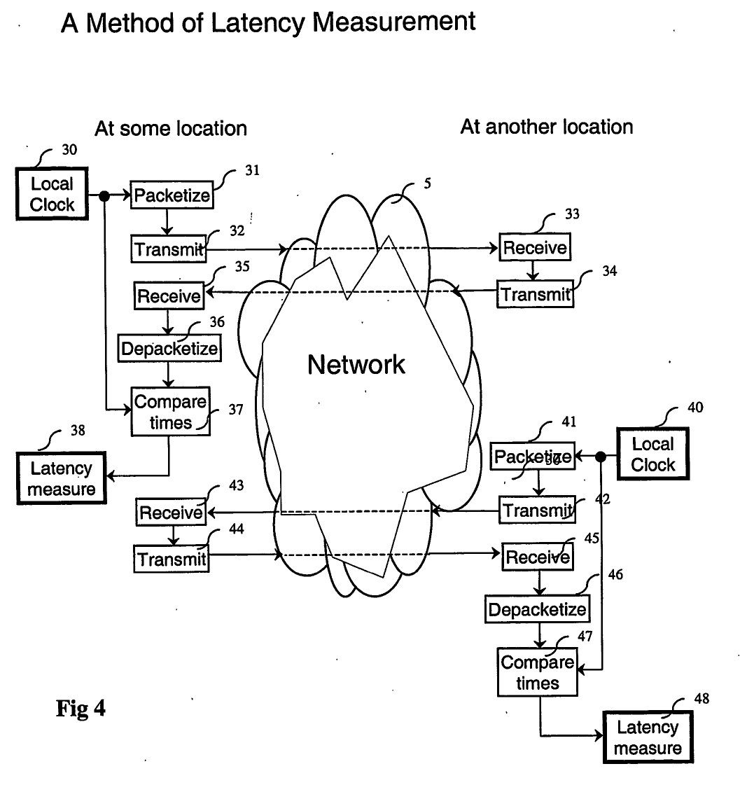

FIG. 4 is a schematic flow chart of the method of measuring latency between two locations to effect adjustment of the system of FIG. 2;

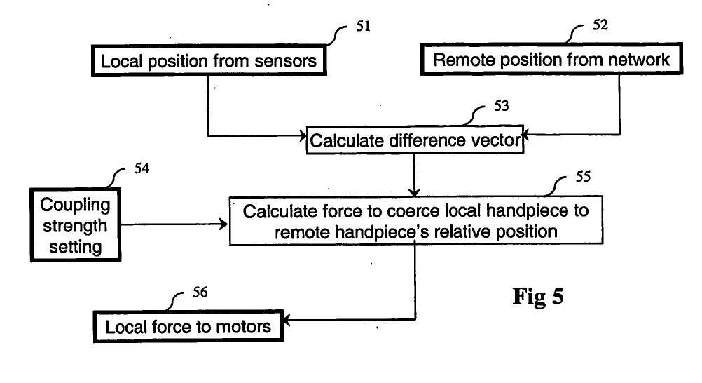

FIG. 5 is a schematic flow chart of the method of calculating forces to be applied locally;

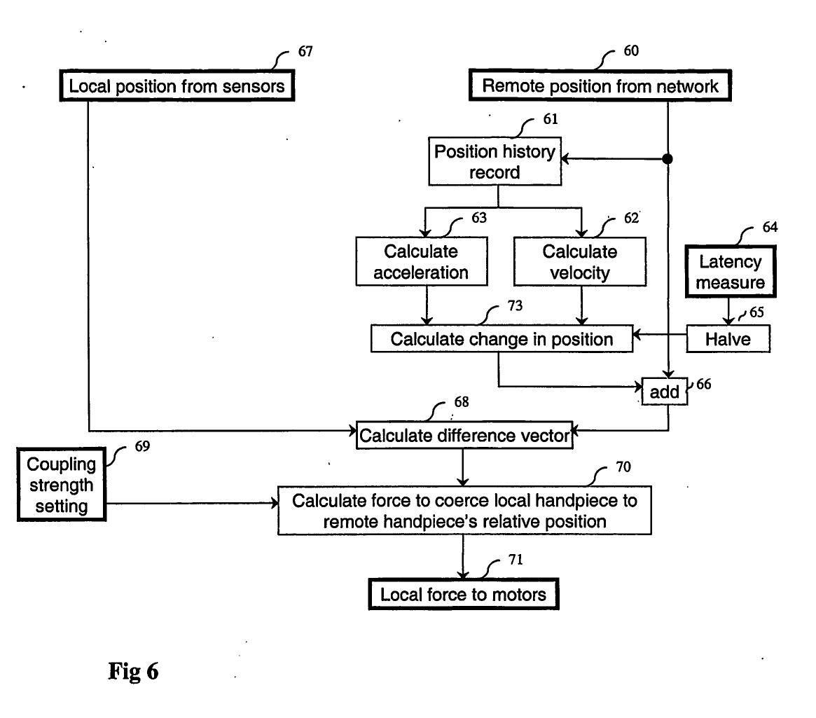

FIG. 6 to 8 are schematic flow charts showing how to put the invention in to practice.

Referring to FIG. 1, in our co-pending European patent application number 01305947.2, there is disclosed a method of providing a haptics output representation of a scene stored, for example, as object model data. In this case a processor 1 includes a program responsive to the position of a haptics output device (for example the Phantom 1.0 Haptic Output device from Sense Able Technologies Inc of the USA), to output reaction forces based upon the object model data. The object model data stored in a data store 3 could define textures, surfaces and locations of fixed or moveable objects which could be perceived by a user of the haptics output interface 2. In some further developments disclosed in the preceding application information held in a data store 4 based upon a player identity 6 allowed player preferences 7 and a gamma correction factor 8 to be used to provide appropriate output adjustment to ensure that different players have approximately the same perception of the output at the haptics output interface 2.

As disclosed the processor 1 was closely coupled to the haptics output interface 2 and could therefore provide substantially continuous detection of location of the user's finger with respect to the x, y, z axes of the device thus allowing real time simulation of the environment defined by the object model data 3.

As hereinbefore mentioned, once a network 5 is introduced between the haptics output interface 2 and the processor 1 continuous communication of the virtual environment and responsive signalling determining the user's response and location by way of an input/output interface 6 to the processor 1 becomes impractical if one requires to update the signalling at substantially continuous rates. Furthermore, latency introduced to the signalling by the network results in an extremely jerky feel to the information being transmitted.

Turning now to FIG. 2, where a plurality of haptic output devices 21, 22 are communicating by way of respective input/output interfaces 25, 26 to respective processors 23, 24 the problems of network latency and signalling limitations become more acute. Thus, if the processor 23 receives by way of a network adaptor 27 signals indicating a position for the haptic output device 22 and instantly seeks to move the haptic device 21 to that position accordingly a substantial jerk in the movement will be apparent. In any event, the user of the haptic output device 21 will be applying a backward force which may inhibit such movement and therefore prevent the processor 23 from aligning the position of the haptic output device 21 with that of the haptic output device 22. Correspondingly, the processor 23 in measuring the location of the haptic output device 21 will send signals back through the network 5 by way of network adaptor 28 to the processor 24, which will attempt to make a corresponding movement in the haptic output device 22. Thus, because the communication between haptic devices 21 and 22 is no longer of a continuous mode but is receiving and transmitting positional information at intervals the experience of the users will be significantly impaired. In addition, the period of time taken for signals to traverse the network (network latency) will further impair user perception.

Thus considering also FIG. 3, it is possible to perceive that if at a location A a user locates the haptic output device 21 “position” and receives a force from the haptic output device then the local position data derived from “position” is derived by the personal computer (PC) 23 and transmitted to the network. At the same time remote position data received from the network is translated by the PC 23 into local force data.

Corresponding position and force derivative data will also be used at location B by the PC 24.

In a practical network the position data and force output are transmitted between each end at approximately five millisecond intervals. Thus each time a new position is received a force is output in an attempt to move the output device to a new position, effectively with a motor pushing against the local user. In effect the user's at each end at positions A and B are coupled together and the two-way activity and data transmission effectively attempts to move both output devices 21 and 22 to corresponding positions. This simulates connection of the two users in a manner such as if they were connected together by some kind of resilience device, for example, a spring or flexible rod. Because there is a reactionary force at each end there can be instability between the two devices because of the feed back loop with deferred transmission of forces may result in an effective positive feedback.

Network latency also results in a tendency for the user to feel a jerkiness in the response of the effector because of the delay in receiving packets by way of the network, particularly if variation in the latency of the network is occurring. This may detract from the quality of the user's experience.

Thus, as hereinbefore described, referring again to FIG. 3, a system comprising two haptic output devices 21, 22 each attached to a personal computer 23,24 which are in turn linked through, say, the internet 5 is susceptible to the network latency problems outlined above.

In use, each computer 23,24 reads the respective position of the haptic output device 21,22 attached thereto and transmits data defining the positional co-ordinates of the handpiece of its haptic display to the other computer which calculates the force required to coerce its respective handpiece of the connected haptic display towards the same co-ordinates. The computer therefore instructs the haptic display to exert that force on the user through the handpiece. The symmetric communication keeps the two displays moving in unison enabling transmission of simple forces, positions, shapes textures and motions to be transmitted between them.

Turning now to FIG. 4, from each of the locations A and B the respective local clock 30 of the PCs 23,24 is used to determine the network latency. Thus, from location A the time from the local clock is bundled into a transmission packet, step 31, and transmitted at step 32 through the network 5. The packet is received at location B, step 33, and is immediately retransmitted at step 34 through the network 5 and is again received at step 35 at location A the received time stripped out (this being the time at which transmission first occurred) and the received time is compared again at step 37 with the local clock 30 to provide, at step 38, a usable measure of latency of the network 5.

Whilst it would be possible to transmit latency information across the network so that each end used the same latency, in the case of network variations a similar latency measurement may be carried out from location B as indicated using the respective local clock 40 to derive a latency measure by way of steps 41 to 47 corresponding to those of steps 31 to 37.

It will be noted that because only one clock is involved in determining the latency measurement synchronisation of the clocks across the two communicating systems is not required. It will of course be appreciated that the packetisation need not necessarily be of specific clock time but may simply be a serial number which is transmitted and received and a look up table is used to determine the time of transmission of the series number packet for comparison with the current time.

Note that each end may perform a respective latency measurement in case there should be a difference between the latency being experienced across the network due to path variations in forward and reverse transmission paths.

Once the latency in each direction has been determined, various methods of countering the latency problem may be used. Some examples of such methods are disclosed in our co-pending patent applications nos. EP02254458.9 and concurrently filed application No GB (our ref A30267).

Considering FIG. 5, in a typical haptic coupling across the network, local positions derived from the haptic output device sensors as indicated at step 51 and the remote position received from the network, step 52, are used to calculate differences and to provide difference vector (step 53) in respect of the x, y and z co-ordinates of the two haptic output devices. The coupling strength or resilience of the coupling between the two devices is then used (step 54) to calculate the force required to coerce the local haptic device to the relative position of the remote device (step 55) so that x, y and z vectors can be transmitted to provide the local force for motors at step 56.

In the present invention, an alternative method of compensating for network latency is proposed which may be used instead of or as an enhancement of the latency compensation methods previously proposed.

Thus rather than using only the received position of the remote handpiece, a prediction of where the next received position will be is used. There are a number of methods proposed for predicting the position including predictions based on dynamic extrapolation from the current position and velocity, improving interpolation by measuring and transmitting contact forces from force sensors on the handpiece, building a model of the remote environment and force field modelling.

Turning then to FIG. 6, in the first of the methods mentioned above, when the remote position is received from the network (step 60) it is stored in a position history record (61) which may simply be a rolling log of the last “x” positions of the handpieces. The next position may now be predicted based upon the received position and a previous position using a known previous position or positions to determine the velocity (62) (estimated from previous motion) and the time interval in which the change occurred. Higher order terms may be taken into account for example using acceleration (63), rate of change of acceleration and so on. This estimation works well with smooth movements where the user is moving the handpiece in free space or where a surface is being traced for example but abrupt motions will be wrongly predicted such as the effect of a user hitting a hard surface at speed or a handpiece being used to feel the boundary of a solid object such as a cube, sphere or wall.

Having determined the previous position, velocity and acceleration the expected change in position to the next received data packet can be calculated (73) with the input of the latency measure (64) as determined using the methods hereinbefore described, adapted by a factor (depending on the number of additional steps being taken between packets, and the predicted change in position may then be added to the current position received from the network (66). The local position determined from sensors in the local handpiece is now used to calculate the difference vector between the predicted position of the remote handpiece and the current position of the local handpiece (68).

Other inputs such as the coupling strength setting between the two handpieces (69) may now be used in association with the difference vector to calculate the force required to coerce the local handpiece to the same relative position of the remote handpiece (70) and x, y and z signals are output to provide the local force to the motors of the local handpiece.

Note that the same algorithm is implemented at both locations “A” and “B”. The position transmitted from each end is the actual position at which the handpiece currently resides and not the predicted position used for the calculation of local force to motors. Any error in the position prediction is of course not correctable in real time but adaptation of the forces to correct the effects of earlier prediction inaccuracies and move the local handpiece towards the remote handpiece position can be made.

If the handpieces are equipped with force sensors then acceleration can be calculated directly rather that effecting a calculation from the positional data. The acceleration data is therefore available earlier if position and force data are transmitted between the remote and local environments.

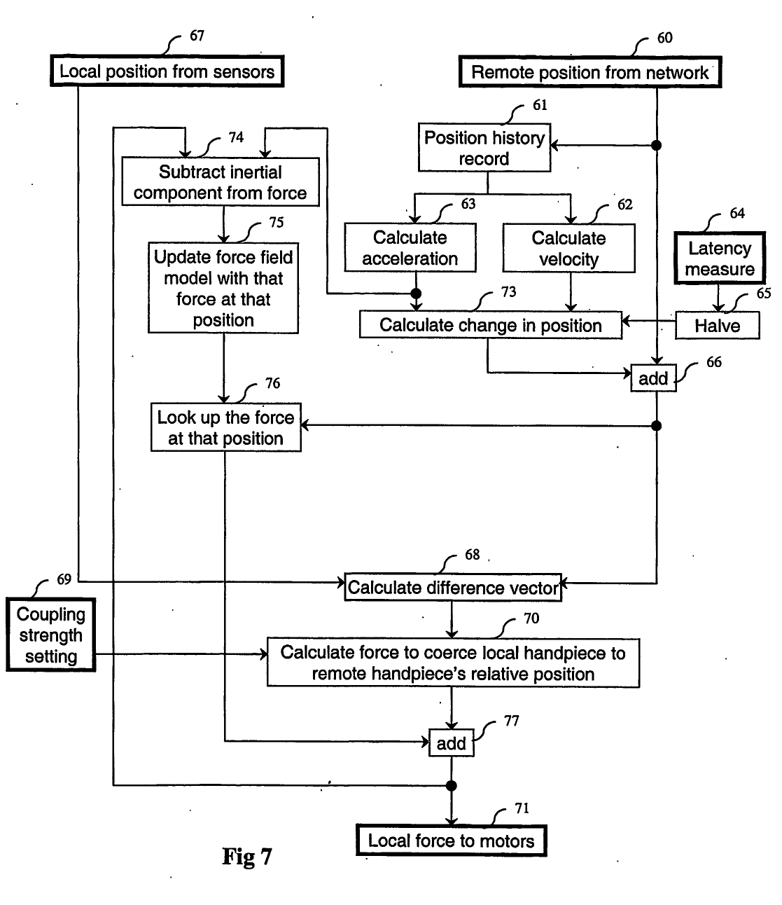

Thus referring to FIG. 7, corresponding steps in the calculation have been described with reference to FIG. 6 and are not further elaborated here. However, here, additional steps are taken to modify the output to the motors of the haptic output device by introducing an element related to the force field model. Thus once the acceleration has been calculated at step 63 it is used together with the actual output force to derive a force field model. Thus at step 74 the inertial component of the acceleration is subtracted from the force and is used to update a stored force field model with the force at the predicted position (75) . When the change in position has been determined, the force at the new position is looked up in the force field model and is added in at step 77 to the calculated force required to coerce the local handpiece towards the calculated position of the remote handpiece so that the accuracy of the force output to the x, y and z motors of the output device is adjusted to take into account that force.

In a further development in the present case, the local PC's each create a model of the space in which the effectors are moving and use the models to influence the local forces output to the motors. The space model data may be derived over time from a determination of positional and/or force data transmitted between the two haptic output devices or may be derived by sampling. A limited data model may be constructed, particularly if sampling is used, say storing data defining impedance or force presence at every tenth moveable point rather than at every point in the space model or interpolating between positions with known values within the model. If a full computer model of the remote environment is available then remote interactions with the environment other than the effect of a remote user can be calculated. For example if the predicted position of the handpiece intercepts a position at which it is known that the remote environment has a solid object of known mechanical properties then a reaction force can be predicted and added to the force applied to the local user via the local handpiece.

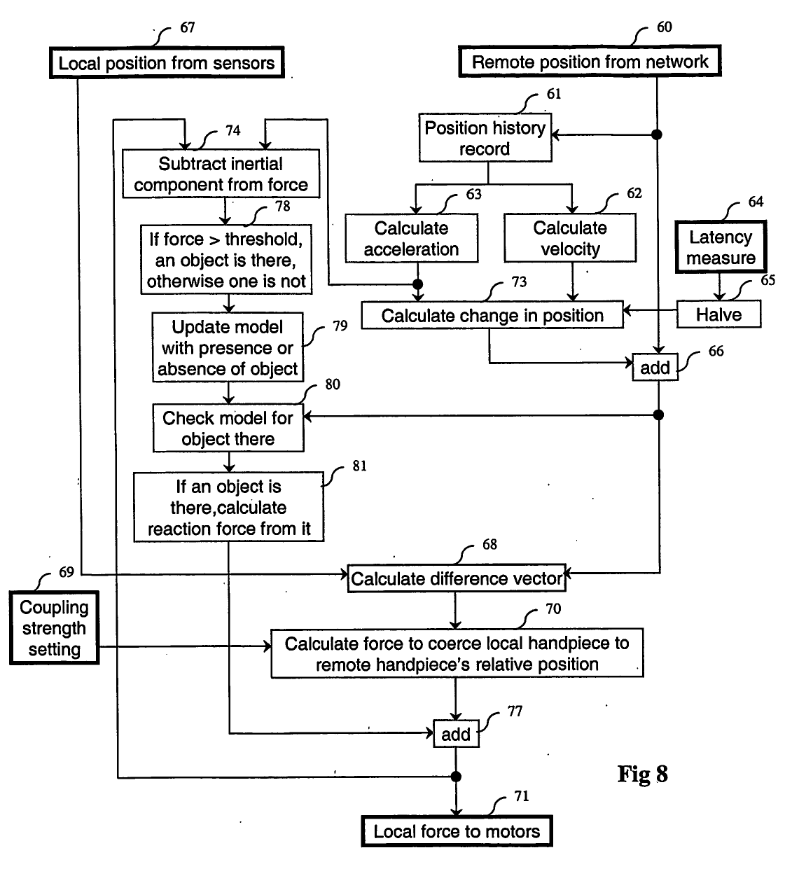

So turning to FIG. 8, in which again steps corresponding to those described with respect to FIGS. 6 and 7 are correspondingly numbered and not further described, the inertial force from step 74 is compared with a threshold which determines the presence or absence of an object at the position (78) and this determination is used to update the model of the operating space (79). Once the change in position has been calculated the predicted position is used to check for the presence of an object (80) and, if so, the reaction force from the object is calculated (81) and then added in at step 77 as before.

It will of course be noted that combinations of force modelling and space modelling may be used to influence the final output to the motors at step 71. It is of course preferable if a full computer model of the remote space is available.

However, it is unlikely that the remote environment can be modelled with total accuracy, nor can it be guaranteed that objects within the remote environment have not been moved as a result of interactions between the users and the environment. The model can be updated over time from positional and force data, for example if past position data shows that at a certain position in a particular area a former movement of the handpiece resulted in the handpiece bouncing off then a tentative record of an object at that position can be added to the model. Thus when the handpiece next moves to that location, a collision with the object in the model is simulated and a reaction force is added in to the output to the user even while the actual data reporting the collision is still in transit through the network.

In further considerations, the models can be updated by averaging in changes over time rather than by replacing current data model simulations completely. Accordingly, the model at the current position blends in to the old model and the more time that is spent at a position the more the new version corresponds with the remote environment and the less the old versions features in the average. Although this can reduce the speed at which the model updates to real changes, for example by an object being unpredictable in its movement due to an interaction with the handpiece and other objects in the model, it increases the resistance of the model to the effects of noise, transients and other spurious effects of the connectionless transmissions. For linear force fields and other linearly combinable effects it is possible to apply a decay factor δ and on each time step multiply the existing value of the model at that position by δ−1 adding it in to δ times the new version.

Since it is unlikely that a complete model of the remote environment can be determined and it would be impractical with current systems to sample the whole space in which a handpiece is working, the result, except in contrived circumstances, is likely to be a sparsely populated model of the environment. A partial model can be built up as the handpiece is moved within the environment. Accordingly, interpolation between known values in the model is necessary. In one example this may be done by finding nearest know value points. Alternatively, a finite element model having less points than those present in the haptic operating space can be used. In this case the model has cells much bigger than the minimal position discrimination of the haptic i/o device but a blending technique between positions might be used to avoid a pixelated feeling to the forces felt by the user. In a more sophisticated arrangement the system may be arranged to determine the most likely arrangement of solid objects within the operating space which match the values of the subset of points having known values.

Other data reduction functions may be incorporated into the modelling—for example where textures are simulated they may be represented as periodic or stochastic functions having relatively few parameters, for example ridges can be specified by period, amplitude and ratio between ridge, slope and trough width. Thus vibrations from surface texture for example when tracing across a remote surface although difficult to predict by interpolation since their small scale means that a number of bumps of a finely textured surface can be moved over during the network latency delay, may be simulated from bulk texture parameters held within the data model.

Other methods of networking latency measurement (e.g. ISDN, TCP over IP or RS232 serial over a modem to modem link over PSTN) could be used instead of UDP. Other methods of network latency measurement (e.g. ‘ping’ time, network performance metrics from other computers on the network, or single direction measurement by synchronised clocks) could be used.

1. A method of activating a haptic output device of the kind responsive to signals defining directional force comprising receiving a series of signals defining a multiplicity of data packets, each packet defining a position measured at one location for transmission to the current location, determining from packet data the information defining a position to which a haptic output device is expected to move, storing historic positional data defining each of a multiplicity of positions to which the haptic output device has moved, deriving a model of the space in which directional forces are being applied at said one location and storing data defining said model, deriving from the historic positional data and the data defining the model an anticipated position and generating output signals defining force and direction to move the haptic output device towards said anticipated position and correcting for differences between the anticipated position and the transmitted position on receipt of subsequent positional data.

2. The method of claim 1 further including signalling in each direction whereby haptic forces applied at one device in reaction to an applied force towards the current defined position are reflected to a corresponding device in the form of current positional signals in a series of return data packets.

3. The method of claim 1 further including determining from the data model of the space the presence of an impeding object whereby modification of the anticipated position and/or force may occur.

4. The method of claim 1 in which latency of the network is determined by transmitting a data packet to the network said packet including a time determinant identity, reflecting the data packet through the network and comparing the received time with the transmitted time to provide a latency parameter from which said damping factor is determined.

5. The method of claim 4 in which at least some transmitted packets carrying positional data also include the time determinant data, some of said time determinant data being returned to permit updating of the latency parameter.

6. The method of claim 1 further including applying a modifying factor to the force and direction signals, said modifying factor being derived from pre determined user preference data.

7. An interactive haptic output terminal in combination with a bi-directional transmission arrangement, the terminal comprising at least a haptic output device and control means, said control means receiving signals from said haptic output device to determine a current position for said device, and to determine from signals received from said transmission arrangement a preferred current position for said haptic output device, said control mean determining an output force and direction required to move said haptic output device from the current position to the preferred position, storing historic positional data defining each of a multiplicity of positions to which the haptic output device has moved, deriving a model of the space in which directional forces are being applied and storing data defining said model, deriving from the historic positional data and the data defining the model an anticipated position and generating output signals defining force and direction to move the haptic output device towards said anticipated position and correcting for differences between the anticipated position and the transmitted position on receipt of subsequent positional data.

8. A terminal as claimed in claim 7 in which the control means receives signals from the haptic output device, said signals containing data defining the position of said device at any particular time, said control means converting said data to signals for transmission to said bi-directional transmission arrangement at predetermined intervals.

9. A terminal as claimed in claim 7 in which the signals defining a preferred current position are generated by an environment simulator, for example a programmed computer.

10. A terminal as claimed in claim 7 in which the signals defining a preferred current position are generated by a corresponding interactive output terminal at the opposed end of the transmission arrangement.
